(19) United States
(12) Patent Application Publication
(10) Pub. No.: US 2026/0342153 A1
(43) Pub. Date: Oct. 29, 2026

(54) ROTOR FOR AN ELECTRIC MACHINE

(71) Applicant: VALEO POWERTRAIN GMBH, Ebern (DE)

(72) Inventors: Manuel MERKLE, Ebern (DE); Andre BUEHLING, Ebern (DE); Andreas PRECHT, Ebern (DE)

(73) Assignee: VALEO POWERTRAIN GMBH, Ebern (DE)

(21) Appl. No.: 19/126,105

(22) PCT Filed: Apr. 3, 2023
(86) PCT No.: PCT/EP2023/058691

§ 371 Date: Apr. 30, 2025

(30) Foreign Application Priority Data
Dec. 15, 2022 (DE) 10 2022 133 514.3

(51) Int. Cl. H02K 1/276; H02K 15/0273; H02K 15/035; H02K 15/038; H02K 15/121

(52) U.S. Cl. CPC H02K 1/276; H02K 15/0273; H02K 15/035; H02K 15/038; H02K 15/121

(57) ABSTRACT

A rotor for an electric machine, in particular for an electric motor, includes a one-piece main body, a stack of rotor laminations which are embedded in the main body and have a number of magnet pockets, and a number of permanent magnets, which are held in the magnet pockets. The magnet pockets being closed at each axial end by the main body.

The invention relates to a rotor for an electric machine, in particular an electric motor.

The rotor is intended in particular for being used in an electric motor which drives a hydraulic pump, such as is used in motor vehicles for providing a volumetric flow of hydraulic oil that is supplied to a clutch actuator, a gearbox actuator, a clutch cooling system, a gearbox lubrication system or the like.

Rotors which have a main body that consists completely of injection-moulded plastic are known. Embedded in this plastic are ferromagnetic particles, which are suitably magnetized to produce a number of permanent magnets with suitable polarization.

Also know are rotors in which a stack of rotor laminations, in which in turn permanent magnets are held, is mounted on a metal shaft. Such rotors require greater manufacturing effort, but are distinguished by a higher magnetic field strength.

The object of the invention is to provide a rotor comprising a stack of rotor laminations that can be produced with less effort.

This object is achieved according to the invention by a rotor for an electric machine, in particular for an electric motor, comprising a one-piece main body, a stack of rotor laminations which are embedded in the main body and have a number of magnet pockets, and a number of permanent magnets, which are held in the magnet pockets, the magnet pockets being closed at each axial end by the main body.

The aforementioned object is also achieved according to the invention by providing a method for producing a rotor for an electric machine, in particular for an electric motor, with the following steps being provided: A stack of rotor laminations which each have a number of openings in such a way that a number of magnet pockets are formed is assembled. Then a ferromagnetic body is pushed into each of the magnet pockets. Subsequently, the stack of rotor laminations fitted with the ferromagnetic bodies is placed into an injection mould, and the stack of rotor laminations is encapsulated with a plastics material, so as to form a main body which extends at least in some sections in the radial direction up to the magnet pockets.

The invention is based on the basic concept of not using separate components for closing the magnet pockets at their axial ends, so that the permanent magnets are held axially therein, but of closing the magnet pockets by means of sections of the main body which serve at the same time as supports for the rotor laminations. The sections of the main body that close the magnet pockets are produced during the production of the main body, that is to say in the same working step, specifically by the cavity of the injection mould being suitably formed. The main body therefore has “closure elements” which are formed in one piece with it and close the magnet pockets at their axial ends.

According to one configuration of the invention, it is provided that the main body extends in the axial direction into the magnet pockets. This produces a form-fitting connection which is effective in the radial direction.

The main body may extend axially further to the outside at the axial ends of the rotor than the magnet pockets, so that the stack formed by the rotor laminations is gripped around in the axial direction and securely fixed.

According to one configuration of the invention, it is provided that the main body forms a planar end face, so that frictional losses are minimized if the rotor is a wet rotor.

The main body may leave some of the magnet pockets exposed on at least one side of the rotor, so that a wall of the injection mould serves as an axial contact surface for the ferromagnetic bodies pushed into the magnet pockets. This allows the ferromagnetic bodies to be positioned very precisely in the axial direction.

The main body preferably extends so far to the outside that the magnet pockets are axially covered in their center. This produces sufficient radial coverage with the ferromagnetic bodies, while at the same time it is ensured that on the sides of the magnet pockets that are facing away from one another in the circumferential direction a region of the ferromagnetic bodies is not covered, so that they can support themselves on a wall of the injection mould.

The main body may be pot-shaped and have a number of through-openings, which extend from the interior space of the main body to an axial end face. The through-openings allow a fluid circulation, with which waste heat can be removed from the interior of the electric motor.

According to one configuration of the invention, it is provided that the rotor laminations are exposed at the outer circumference of the rotor, so that the air gap between the rotor laminations and a stator surrounding the rotor is kept as small as possible.

A rotor shaft which is injection-moulded into the main body in a form-fitting manner is preferably provided. This has the advantage that there is no need for a separate step for mounting the rotor shaft.

According to one configuration of the invention, it is provided that the ferromagnetic bodies are pushed into the magnet pockets in an unmagnetized state and are only magnetized after the main body has been moulded onto the stack of rotor laminations. This has the advantage that both the introduction of the ferromagnetic bodies into the magnet pockets and the injection moulding are very much easier, because it is not necessary to handle a magnetized stack of rotor laminations.

According to one configuration, it is provided that the main body is provided with a geometrical positioning formation. The positioning formation, for example a number of grooves on the lateral surface of the main body, ensures the precise positioning of the rotor in the circumferential direction when it is placed into a mould in order to magnetize the ferromagnetic bodies.

The invention will be described below on the basis of two embodiments which are illustrated in the appended drawings. In the drawings:

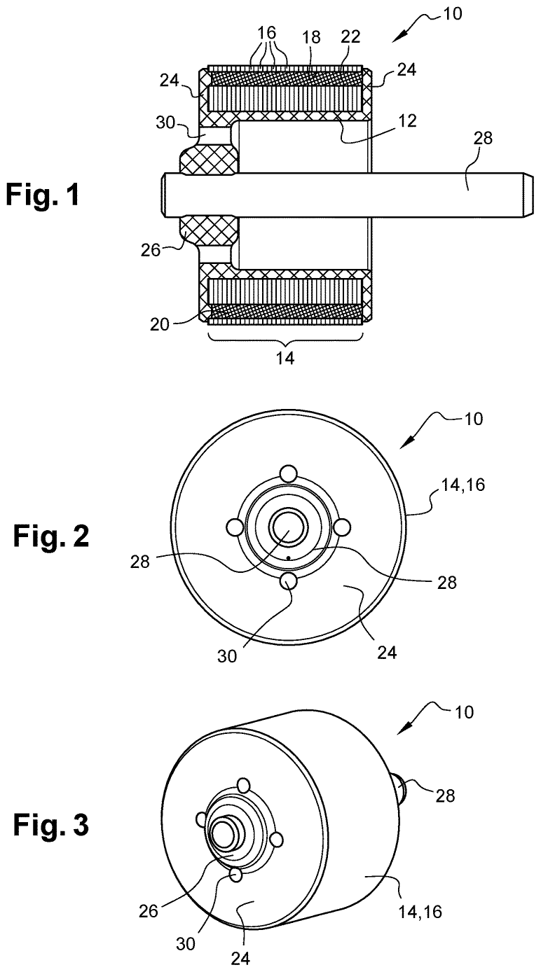

FIG. 1 shows a longitudinal section through a rotor according to a first embodiment of the invention;

FIG. 2 shows a plan view of the rotor from FIG. 1;

FIG. 3 shows a first perspective view of the rotor from FIG. 1;

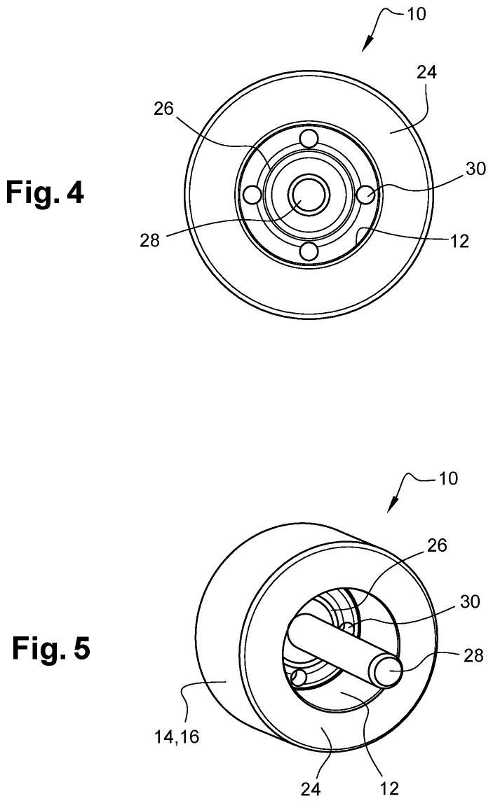

FIG. 4 shows a view from below of the rotor from FIG. 1;

FIG. 5 shows a second perspective view of the rotor from FIG. 1;

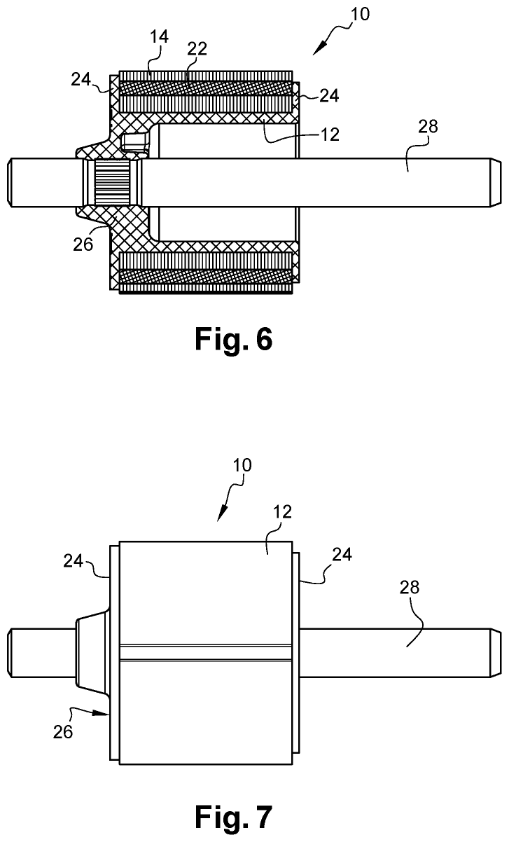

FIG. 6 shows a longitudinal section through a rotor according to a second embodiment of the invention;

FIG. 7 shows a side view of the rotor from FIG. 6;

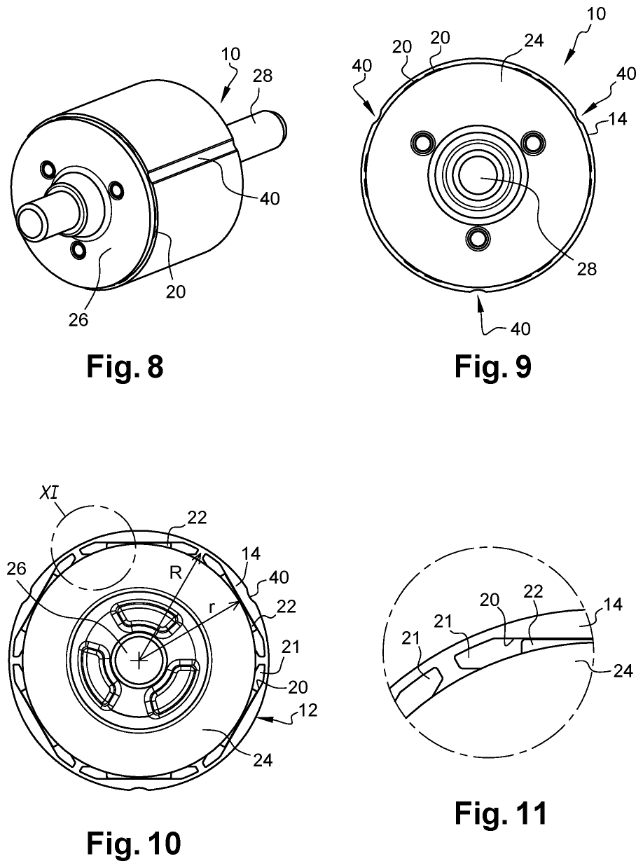

FIG. 8 shows a perspective view of the rotor from FIG. 6;

FIG. 9 shows a plan view of the rotor from FIG. 6;

FIG. 10 shows a view from below of the rotor from FIG. 6; and

FIG. 11 shows the detail XI from FIG. 10 on an enlarged scale.

FIGS. 1 to 5 show a rotor 10 according to a first embodiment, which is intended for being used together with a stator of an electric motor and for driving a hydraulic pump, such as is used in the drive train of a vehicle, for example in order to switch an actuator or to lubricate or cool components.

The rotor 10 has a pot- or cup-shaped main body 12, which consists of plastic and is injection-moulded.

The main body 12 extends along the inner surface of a stack 14 of rotor laminations 16, which are securely held against and on the main body. The rotor laminations 16 consist of ferromagnetic material.

Each of the rotor laminations 16 is provided with a number of recesses 18, which together form a number of magnet pockets 20, which extend through the stack 14 in the axial direction. A permanent magnet 22 is arranged in each of the magnet pockets.

The magnet pockets 20 are closed at their two axial ends by the main body 12, specifically in each case by a flange 24 which is formed in one piece with it and extends in the radial direction beyond the magnet pockets and up to the outer circumference of the stack 14 of rotor laminations 16. In this way it is ensured that the permanent magnets 22 are fixed in the magnet pockets 20 in the axial direction.

As can be seen in FIG. 1 for the left flange 24, it extends slightly into the magnet pockets 20, so that a form-fitting connection is obtained there.

It may also be provided that the flange on the right side of the stack 14 of rotor laminations 16 extends into the magnet pockets 20 ending there.

The pot-shaped main body 12 also has a base 26, which serves here for receiving a rotor shaft 28. The rotor shaft 28 is injection-moulded into the base 26 of the main body 12.

Also provided in the base 26 are a number of through-openings 30, through which hydraulic fluid can pass from the outer side of the rotor into the interior space, or vice versa.

As can be seen in particular in FIGS. 3 and 5, the flange 24 forms on the corresponding side of the rotor 10 a planar end face, which extends almost up to the outer circumference of the rotor 10. The outer circumference itself is formed by the outer circumferential surface of the stack 14 of rotor laminations 16, which are exposed on the outside.

It is possible in principle to push the permanent magnets 22 into the magnet pockets 20 of the stack 14 of rotor laminations 16 and subsequently place this stack into an injection mould, where it is encapsulated with the material forming the main body 12. According to a preferred embodiment, however, an unmagnetized body of ferromagnetic material is respectively pushed into each of the magnet pockets 20. Subsequently, the stack 14 fitted with such ferromagnetic bodies is placed into the injection mould and encapsulated with the material forming the main body 12. Only subsequently are the ferromagnetic bodies magnetized by means of external coils, so that the permanent magnets 22 are formed.

FIGS. 6 to 11 show a rotor according to a second embodiment. The same reference signs are used for the components and features known from the first embodiment, and to this extent reference is made to the explanations above.

The difference between the first and second embodiments is that in the case of the second embodiment the magnet pockets 20 are only completely or almost completely covered by the flange 24 on one side (here on the side of the base 26), whereas they are not completely covered on the other side (that is to say the side facing away from the base 26).

As can be seen in FIG. 10, the magnet pockets have an elongated cross section when viewed in section or an end-on view. Their direction of extent is perpendicular or tangential to a radius r, which runs through their center. Consequently, the ends of each magnet pocket 20, facing away from one another in the circumferential direction, lie on a greater radius R than the center of each magnet pocket, which lies on the radius r. The main body 12, to be more precise the flange 24, on one side of the rotor 10 is only formed up to such a radius (here the radius r) that some of the magnet pockets 20 are not covered. To put it another way, some of the magnet pockets 20 are exposed, specifically on the sides facing away from one another in the circumferential direction. These are denoted in FIG. 11 by the reference sign 21. As a result, some of the ferromagnetic bodies 22 or permanent magnets 22 arranged in the magnet pockets 20 are also exposed.

The injection mould may as a result be designed such that the ferromagnetic bodies 22 can lie against a wall of the injection mould. As a result of this, the ferromagnetic bodies 22 are precisely positioned in the axial direction. On the opposite side, the flange 24 ensures that the ferromagnetic bodies 22 are fastened in the axial direction. It is not absolutely necessary that the flange 24 completely closes the magnet pockets 20 there.

The rotor 10 or its main body 12 is provided with a number of geometrical positioning formations 40. The positioning formations are formed here as grooves 40 in the lateral surface of the main body 12 that run in the axial direction. These ensure the precise positioning of the rotor 10 in the circumferential direction when it is placed into a mould in order to magnetize the ferromagnetic bodies 22.

1. Rotor for an electric machine, in particular for an electric motor, comprising a one-piece main body, a stack of rotor laminations which are embedded in the main body and have a number of magnet pockets and a number of permanent magnets, which are held in the magnet pockets the magnet pockets being closed at each axial end by the main body.

2. Rotor according to claim 1, wherein the main body extends in the axial direction into the magnet pockets.

3. Rotor according to claim 1, wherein the main body extends axially further to the outside at the axial ends of the rotor than the magnet pockets

4. Rotor according to claim 1, wherein the main body forms a planar end face.

5. Rotor according to claim 1, wherein the main body leaves some of the magnet pockets exposed on at least one side of the rotor.

6. Rotor according to claim 5, wherein the main body extends so far to the outside that the magnet pockets are axially covered in their center.

7. Rotor according to claim 1, wherein the main body is pot-shaped and a number of through-openings are provided, which extend from the interior space of the main body to an axial end face.

8. Rotor according to claim 1, wherein the rotor laminations are exposed at the outer circumference of the rotor.

9. Rotor according to claim 1, wherein a rotor shaft which is injection-moulded into the main body in a form-fitting manner is provided.

10. Rotor according to claim 1, wherein the main body is formed in one piece and from plastic.

11. Rotor according to claim 1, wherein the main body is provided with a geometrical positioning formation.

12. Method for producing a rotor for an electric machine, in particular for an electric motor, by means of the following steps:
assembling a stack of rotor laminations which each have a number of openings in such a way that a number of magnet pockets are formed,
pushing a ferromagnetic body into each of the magnet pockets,
placing the stack of rotor laminations fitted with the ferromagnetic bodies into an injection mould,
encapsulating the stack of rotor laminations with a plastics material, so as to form a main body which extends at least in some sections in the radial direction up to the magnet pockets.

13. Method according to claim 12, wherein the ferromagnetic bodies are pushed into the magnet pockets in an unmagnetized state and are magnetized after the main body has been moulded onto the stack of rotor laminations.

14. Rotor according to claim 2, wherein the main body extends axially further to the outside at the axial ends of the rotor than the magnet pockets.

15. Rotor according to claim 2, wherein the main body forms a planar end face.

16. Rotor according to claim 2, wherein the main body leaves some of the magnet pockets exposed on at least one side of the rotor.

17. Rotor according to claim 2, wherein the main body is pot-shaped and a number of through-openings are provided, which extend from the interior space of the main body to an axial end face.

18. Rotor according to claim 2, wherein the rotor laminations are exposed at the outer circumference of the rotor.

19. Rotor according to claim 2, wherein a rotor shaft which is injection-moulded into the main body in a form-fitting manner is provided.

20. Rotor according to claim 2, wherein the main body is formed in one piece and from plastic.
